(19) United States
(12) Patent Application Publication
(10) Pub. No.: US 2025/0059384 A1
(43) Pub. Date: Feb. 20, 2025

(54) ANTIMICROBIAL MODIFIED MATERIAL FOR TREATMENT OF FLUIDS

(71) Applicant: Research Foundation of the City University of New York, New York, NY (US)

(72) Inventors: William Blanford, Fresh Meadows, NY (US); Gregory O'Mullan, Garden City, NY (US); Robert Engel, Forest Hills, NY (US)

(21) Appl. No.: 18/940,397

(22) Filed: Nov. 7, 2024

Related U.S. Application Data
(63) Continuation-in-part of application No. 17/055,681, filed on Nov. 16, 2020, now abandoned.
(60) Provisional application No. 62/671,496, filed on May 15, 2018.
(60) Provisional application No. 63/562,463, filed on Mar. 7, 2024.

(51) Int. Cl. C09D 5/16; C09D 7/20

(52) U.S. Cl. CPC C09D 5/1625; C09D 5/1687; C09D 7/20

(57) ABSTRACT

A method for treating a fluid is provided. Particles are coated with quaternary ammonium or phosphonium compounds (“quats”). Fluid is passed over the particles. The biocidal properties of the quats treats the fluid.

### CROSS-REFERENCE TO RELATED APPLICATIONS

This application claims priority to, and is a continuation-in-part of, U.S. patent application Ser. No. 17/055,681 (filed Nov. 16, 2020), which is a national stage entry of PCT/US19/32471 (filed May 15, 2019) which claims priority to U.S. Patent Application 62/671,496 (filed May 15, 2018). This application also claims priority to U.S. patent application 63/562,463 (filed Mar. 7, 2024). The entirety of each of these applications is incorporated herein by reference.

### BACKGROUND OF THE INVENTION

There is an unmet need for efficient means of removal of microbial pollutants from fluids without addition of toxic chemicals to the subject solution or through size-exclusion filtration of that solution which is often energy intensive. There is a similar need for efficient means of avoiding microbial colonization of surfaces which may lead to degradation of those materials or compromise of fluids in contact with them or risk of exposure to infection by users of those materials or fluids.

To those ends, there are many varieties of polycationic-based antimicrobial chemicals (e.g. polyammonium such as in Engel et al. (Polycations. 2009. 18. The synthesis of polycationic lipid materials based on the diamine 1,4, diazabicyco [2.2.2]octane. Chemistry and Physics of Lipids 158 (1): 61-69); polyphosphonium as in Shevchenko and Engel (Shevchenko, V. and R. Engel. 1998. Polycations. III. Synthesis of polyphosphonium salts for use as antibacterial agents. Heteroatom Chemistry 9 (5): 495-502) and multiple means of associating these compounds with surfaces to instill antimicrobial properties into the resulting altered surface (U.S. Pat. Nos. 8,999,316; 8,470,351; 8,329,155; 7,241,453; U.S. 7,285,286). These polycationic chemicals, which are often referred to as “quats”, have been demonstrated to exhibit broad ranges of antimicrobial activity against bacteria, archaea, and protozoa as well as fungi, algae, and certain viruses (e.g. U.S. Pat. No. 8,999,316; Isquith et al. 1972. Surface-bonding antimicrobial activity of an organosilicon quaternary ammonium chloride. Applied Microbiology 24 (6): 859-863; and Abel et al. 2002. Preparation and investigation of antibacterial carbohydrate-based surfaces. Carbohydrate Research 337 (24): 2495-2499).

Current methods for treatment for the removal of viable microbes from fluids (e.g. water or air), rely primarily on six approaches: 1) size-exclusion of microbes from the advecting fluid (e.g. filter membranes, tangential filtration, hollow fiber filtration, reverse osmosis); 2) the addition, in solution, of chemical biocides or oxidants (e.g. chlorine, quats, bleach, ozone (Kahrilas G. A., J. Blotevogel, P. S. Stewart, and T. Borch. 2015. Biocides in Hydraulic Fracturing Fluids: A Critical Review of Their Usage, Mobility, Degradation, and Toxicity. Environmental Science & Technology, 49 (1)) to the subject fluid; 3) adhesion or adsorption of microbes to a stationary porous media (e.g. activated carbon (Sukdeb P., J. Joardar, and, and J. M. Song. 2006. Removal of E. coli from Water Using Surface-Modified Activated Carbon Filter Media and Its Performance over an Extended Use. Environmental Science & Technology 40 (19), 6091-6097.)); 4) electromagnetic radiation (e.g. ultraviolet (UV) Reed, 2010) of fluids; 5) contact with media columns containing toxic metals (e.g. silver or copper (Grass G., C. Rensing, and M. Solioz. 2011. Metallic Copper as an Antimicrobial Surface. Applied Environment Microbiology. March; 77 (5): 1541-1547.); 6) freeze/thaw or heating of the fluid for distillation or for lysis of cells.

The discussion above is merely provided for general background information and is not intended to be used as an aid in determining the scope of the claimed subject matter.

### SUMMARY

A method for treating a fluid is provided. For example, particles are coated with quaternary ammonium or phosphonium compounds (“quats”). Fluid is passed over the particles. The biocidal properties of the quats treat the fluid.

In a first embodiment, a marine paint is provided. The marine paint comprising less than 5% (wt) water; greater than or equal to 3% (wt) of at least one quaternary ammonium salt; 12%+6% (wt) talc; 12%+6% (wt) of a polymer formed from an epoxy resin and bisphenol A; 12%+6% (wt) barium sulfate; 12%+6% (wt) titanium dioxide; 12%+6% (wt) a silicate; 11%+6% (wt) butanol; 5%+4% (wt) of a hydrocarbon solvent; 15%+12% (wt) of an arene solvent; 0-0.2% (wt) of triethylene tetramine; 0-22% (wt) of p-chloro-a, a, a,-trifluorotoluene; and 0-2% (wt) of an organic alcohol.

In a second embodiment, a marine paint is provided. The marine paint comprising less than 5% (wt) water; greater than or equal to 5% (wt) of at least one quaternary ammonium salt; 12%+6% (wt) of a polymer formed from an epoxy resin and bisphenol A; 12%+6% (wt) barium sulfate; 12%+6% (wt) a silicate; 5%+4% (wt) of a hydrocarbon solvent; 15%+12% (wt) of an arene solvent; 0-0.2% (wt) of triethylene tetramine; 0-22% (wt) of p-chloro-a, a, a,-trifluorotoluene; and 0-2% (wt) of an organic alcohol.

In a third embodiment, a marine paint is provided. The marine paint comprising less than 5% (wt) water; greater than or equal to 5% (wt) of at least one quaternary ammonium salt; 12%+6% (wt) of a polymer formed from an epoxy resin and bisphenol A; and 12%+6% (wt) a silicate.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1A is a graph displaying heterotrophic bacterial levels as assessed by R2A plate counts in HVAC test waters prior to flushing through columns (Pre) and after flushing through coated porous media whose coating contains ADBAC antimicrobial agent (Treated) and after that the same media, but whose coating does not contain biocide (Control).

FIG. 1B is a graph displaying heterotrophic bacterial levels as assessed by SimPlate counts in HVAC test waters prior to flushing through columns (Pre) and after flushing through coated porous media whose coating contains ADBAC antimicrobial agent (Treated) and after that the same media, but whose coating does not contain biocide (Control).

FIG. 2A is an image displaying taxonomy of 34 colonies (14 pre and 20 post) from HVAC R2A spread plates based on 16S rRNA sequences evaluated in RDP classifier. The relative percent representation of these taxa (y-axis) in pre- and post-column (x-axis) isolates is shown.

FIG. 2B is a table displaying taxonomy of 34 colonies (14 pre and 20 post) based on 16S rRNA sequences evaluated in RDP classifier.

FIG. 3A is a table summarizing Bisphenol A and benzalkonium chlorides in water extraction tests.

FIG. 3B is a graph summarizing the results of Enterococcus faecalis in column studies of low-VOC-coated media.

FIG. 4 is a graph summarizing the results of Pseudomonas aeruginosa in column studies of low-VOC-coated media.

FIG. 5 is a graph summarizing the results of Legionella pneumophila in column studies of low-VOC-coated media.

FIG. 6 shows a table of mass fraction composition of select coatings.

### DETAILED DESCRIPTION OF THE INVENTION

Many disinfection procedures, often involving the dosing of biocide solutions (e.g., sodium hypochlorite, hydrogen per-oxide, silver salts, quaternary ammonium salts), have been utilized to control microbial growth in industrial waters, including cooling towers. However, these approaches can require frequent monitoring of biocide levels, and the oxidant nature of many of these chemicals can contribute to safety concerns with their handling, to corrosion to the system, and to the formation of toxic disinfection byproducts when added in large doses. There is also increasing awareness that not all biocontrol strategies have similar efficiency toward all microbes and the differences in microbial structure, physiology, and ecology can influence the general efficacy of biocides. For example, in drinking water treatment, it is well known that Cryptosporidium parvum oocysts are highly resistant to chlorine. Therefore, filtration and/or settling, commonly applied in addition to disinfection, has been recommended for the treatment of drinking water from surface water systems or ground-water under the direct influence of surface water to avoid Cryptosporidium outbreaks. Similarly, the association of Legionella pneumophila with protozoan host species can provide protection from harsh environ-mental conditions, including some disinfection procedures. Because the efficiency of treatment for a given biocontrol strategy may vary for differing microbial taxa some users prefer to use more than one control strategy and it is helpful to evaluate new technologies using both natural diverse communities and select cultured species representing taxa of interest in industrial water treatment.

Alkylated quaternary ammonium compounds, which are commonly referred to as ‘quats’, are widely used as disinfectants in hospital settings and are known to be effective against a wide range of bacteria, including L. pneumophila, several species of Enterococcus including E. faecium and Pseudomonas aeruginosa. Quats are typically utilized in solution (e.g., for disinfecting the water in a tank) or by spraying on to a surface during routine maintenance (e.g., scrubbing of tank walls or food preparation areas).

In some embodiments of the disclosed method, the quats have been immobilized on to activated carbon powder for water treatment and into dental sealers to improve antimicrobial and antibiofilm properties. Immobilization may have added benefits due to their bactericidal action being attributed to a wide range of mechanisms including denaturation of cell proteins, disruption of the cell membrane, and inactivation of energy-producing enzymes. In some embodiments, the quats are embedded within surface coatings, as accomplished in the porous treatment media described elsewhere in this disclosure.

This disclosure pertains to the use of quaternary ammonium and phosphonium compounds (“quats”) as antimicrobial agents to treat fluids. More specifically, this disclosure pertains to antimicrobial agents that are silicon-free such that it excludes silicon-containing antimicrobial quats (e.g. 3-(trimethoxysilyl) propyldimethyloctadecyl ammonium (BIOGUARD®; SANITIZED®); Silicone Dialkyl Quats; Morais D. S., R. M. Guedes, and M. A. Lopes, 2016, Antimicrobial Approaches for Textiles: From Research to Market: Review. Materials) that are more easily hydrolyzed when associated with surfaces. This disclosure also excludes triclosan-based antimicrobials (e.g. MICROBAN®; Morais D. S., R. M. Guedes, and M. A. Lopes, 2016, Antimicrobial Approaches for Textiles: From Research to Market: Review. Materials), and silver-containing and copper-containing compounds and particles (i.e. the antimicrobial agent is triclosan-free, copper-free and silver-free).

In another embodiment, this disclosure provides a treatment method that uses pea-gravel with a marine coating supplemented with a quat salt such as alkyldimethylbenzylammonium chloride (ADBAC or benzalkonium chloride). This disclosure describes the method's antimicrobial performance and coating stability in aqueous environments. The method reduced bacterial loads in heating, ventilation, and air conditioning (HVAC) water by an average of 94% from pre-flush levels (10 colony forming unit (CFU)/mL) when assessed with R2A spread plates and 83% reductions with SimPlates. There was no observed statistical difference between the average of pre- and post-flush waters from four tests of the media without ADBAC. Taxonomic identification, by 16S rRNA gene sequencing, of colonies drawn from pre- and post-ABDAC R2A plates showed similarities with taxa observed in high frequency from prior cultivation-independent surveys of other cooling tower systems.

Unlike many other antimicrobials (e.g. copper, silver, antibiotics, etc.) quats are not consumed when they interact with a microorganism or the environment. Quats do not interact with the metabolic activity of cells (e.g. such as tetracycline (Chopra I and M. Roberts. 2001. Tetracycline Antibiotics: Mode of Action, Applications, Molecular Biology, and Epidemiology of Bacterial Resistance. Microbiology and Molecular Biology Reviews. June; 65 (2): 232-260.); polyhexamethylene biguanide (PHMB) (Chindera K., M. Mahato, A. K. Sharma, H. Horsley, K. Kloc-Muniak, N. F. Kamaruzzaman, S. Kumar, A. McFarlane, J. Stach, T. Bentin,8 and L. Gooda. 2016). The antimicrobial polymer PHMB enters cells and selectively condenses bacterial chromosomes. Scientific Reports. Doi: 10.1038/srep23121) nor are quats prone to promote evolution of resistant organisms (Gerba, C. P. 2015. Quaternary Ammonium Biocides: Efficacy in Application. Applied Environmental Microbiology January; 81 (2): 464-469). Quats do not require cellular activity or uptake for antimicrobial action since the mechanism is impingement and physical lysis.

The method of antimicrobial action for quats is understood to occur primarily via physical disruption of the cell membrane/wall by impingement and/or electrostatic disruption causing lysis of the cell (Rutala, W. A. and D. J. Weber, 2015. Disinfection, Sterilization, and Control of Hospital Waste in Mandell, Douglas, and Bennett's Principles and Practice of Infectious Diseases (Eighth Edition)). The exact mode of action for viral species is less well constrained, but the compounds have been demonstrated to often act as virucidal against lipophilic (enveloped) viruses but are less known as a functional virucidal against hydrophilic (non-enveloped) viruses (Rutala, W. A. and D. J. Weber, 2015. Disinfection, Sterilization, and Control of Hospital Waste in Mandell, Douglas, and Bennett's Principles and Practice of Infectious Diseases (Eighth Edition), 2015; U.S. Pat. No. 8,999,316).

This technology seeks to lessen levels of viable microbes contained in gases and liquids advecting (i.e. flowing through the porous media), contained within vessels whose surfaces are coated with quats, or contained within pipe, tubes, or other agents whose surfaces are coated with quats for conveyance of fluids.

In one embodiment, a system for treating a fluid is provided. Examples of fluids include, among others, water, organic liquids, air or other gases and aqueous solutions. In another embodiment, a system for storing a fluid is provided. In one embodiment, the fluid is stored for at least 6 hours.

The media is composed of particles that may be loose or consolidated (such as in the difference between sand and sandstone). In those embodiments where the media is a porous media it has an intrinsic permeability of 10⁶ centimeters (cm) squared or greater and hence does not rely on size-exclusion as the primary means of reducing microbial levels during passable air, water, or other fluids. Intrinsic permeability (Freeze, R. A., and Cherry, J. A., 1979, Groundwater: Englewood Cliffs, NJ, Prentice-Hall, 29 p.) is a property of the porous media and is independent of the properties such as dynamic viscosity and density of the fluid passing through it (Freeze, R. A., and Cherry, J. A., 1979, Groundwater: Englewood Cliffs, NJ, Prentice-Hall, 29 p.). As an example based on the empirical equation for laminar flow of an incompressible fluid passing through porous medias as formulated by Henry Philibert Gaspard Darcy in 1856 (Freeze, R. A., and Cherry, J. A., 1979, Groundwater: Englewood Cliffs, NJ, Prentice-Hall, 29 p.), the displacement pressure in centimeters of water involved in the flow of 100 cubic centimeters per second of water through the long axis of a cylinder 10 cm in diameter with a depth of 100 cm of water at sea-level and typical environmental temperatures with an intrinsic permeability of 10⁻⁶ cm² would be the displacement pressure of 1.3 meters of water which is approximately 18.5 pounds per square inch (psi).

The media may be porous or non-porous. The material being used in the subject treatment systems relies upon the lysing of microbes at the surface of the particles or walls of vessels (e.g. pipes, or other agents of fluid conveyance) as the advecting fluid encounters the surfaces of these subject items (e.g. treated gravel). It should be noted that the particles or surfaces themselves may be internally porous (e.g. gravel composed of sandstone where the sandstone has voids within), but that the internal void volume of those particles is poorly accessible (i.e. lower intrinsic permeability) and hence does not significantly contribute to microbial loss. Further, it should be noted that the total porosity of the media is a product of both the intra-particle porosity, which arises from pores within the individual particles (e.g. pores within individual sandstone gravel), and inter-particle porosity, which arises from pores between individual particles (e.g. pores between the assemblage of sandstone gravel grains). In this treatment technology, it is thought that most of the interactions between microbes and the particles or the fluid holding or conveying surfaces are at or near the surface of those items.

Examples of suitable media may include plastic media, elastomeric media, cellulosic media, epoxy media and silicate media. Examples of plastic media include, but are not limited to, three-dimensional plastic objects such as spheres, plastic membranes, polyethylene terephthalate (or polyester) (PETE or PET), high-density polyethylene (HDPE), polyvinyl chloride (PVC), low-density polyethylene (LDPE), polypropylene (PP), polystyrene (or Styrofoam) (PS), acrylonitrile butadiene, polycarbonate (PC), polylactic acid (or polylactide) (PLA), poly(methyl 2-methylpropenoate) (or acrylic) (PMMA), acetal (or polyoxymethylene, POM), styrene, fiberglass, and nylon. Examples also include polytetrafluoroethylene (PTFE) (e.g. TEFLON®), fluorinated ethylene propylene copolymers (FEP), perfluoroalkoxy (FEP, PFA), and copolymers of ethylene and tetrafluoroethylene (ETFE).

Examples of elastomeric media include natural rubbers, butyl rubber (isobutene-isoprene), chloroprene (neoprene), polychloroprene, baypren, styrene-butadieneblock copolymers, polyisoprene, polybutadiene, ethylene propylene rubber, styrene-butadiene, ethylene propylene diene rubber, silicone elastomers, halogenated butyl rubber (chlorobutyl rubber, bromobutyl rubber), fluoroelastomers (i.e. fluoropolymer elastomer), polyurethane elastomers, nitrile rubbers (including copolymer of butadiene and acrylonitrile, NBR, also called Buna N rubbers), polyurethanes,, fluorosilicone, nitrilebutadiene, epichorohydrin rubber, polyacrylic rubber, silicone rubber, polyetherblock amines, chlorosulfanated polyethylene (e.g. HYPALON®), and ethylene-vinyl acetate, natural polyisoprene: cis-1,4-polyisoprene natural rubber (NR) and trans-1,4-polyisoprene gutta-percha, synthetic polyisoprene (IR for isoprene rubber), polybutadiene (BR for butadiene rubber), chloroprene rubber (CR), polychloroprene, Baypren, styrene-butadiene rubber (copolymer of styrene and butadiene, SBR, and/or copolymer of divinylbenzene and styrene), Hydrogenated Nitrile Rubbers (HNBR) such as THERBAN® and ZETPOL®, EPM (ethylene propylene rubber, a copolymer of ethylene and propylene) and EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone Rubber (FVMQ), fluoroelastomers (FKM, and FEPM, TECNOFLON®, FLUOREL®, AFLAS® and DAI-EL®, perfluoroelastomers (FFKM) TECNOFLON® PFR, KALREZ®, CHEMRAZ®, PERLAST®, polyether block amides (PEBA), chlorosulfonated polyethylene (CSM), ethylene-vinyl acetate (EVA).

Examples of cellulosic media include, but are not limited to, wood, cloth, cork, chitin, cellulose derivative (cellulose esters and cellulose ethers) materials include cellulose acetate, cellulose acetate propionate, cellulose acetate butyrate, nitrocellulose, carboxymethyl cellulose, methyl cellulose, ethyl cellulose, hydroxyethyl cellulose, hydroxypropyl cellulose, hydroxypropyl methylcellulose, and LYOCELL® (a class of human-made cellulose fibers), microcrystalline cellulose, nanocelluloses, cellulose nanofibrils and cellulose nanocrystals.

Examples of silicate media include stones such as sedimentary stones and igneous stones; and glass media such as glass beads, shards, or fibers.

The system has a media (e.g. a porous or non-porous media) that comprises media particles that are 1 millimeter or greater in diameter. In various practices, the disclosed materials could have a range and variation of particle size (e.g. 1 mm to 300 mm; 1 mm to 40 mm) and shapes (e.g. irregular shapes with high surface area to volume ratios). These choices impact, and hence enable, design selection of average and variation in pore sizes and shape and thus in intrinsic permeability, solute flow path length and direction, and fluid-surface interactions. In one embodiment, the media is comprised of particles with a diameter between 0.64 cm to 1.3 cm (e.g. pea-gravel).

In one embodiment, the quats are coated into a media that is contained within an air-stripper. Unwanted volatile chemicals or microbes are removed by pumping tainted water to the top of a large vertical vessel and “raining” it downward through the vessel. In a counter direction, air or other gas is vertically passed upward through the cascading water.

By adding quats to surfaces of porous media or the bulk material composing that media, the resulting media could then be designed for the treatment of microbial agents in fluids under a range of conditions and performance objectives. These fluids to be treated or fluid treatment components could include, but are not limited to, storm waters, industrial waters, food and beverage liquids, pharmaceutical solutions, ventilation gases, heat and volatile exchangers and numerous other systems.

The quats contain at least one carbon chain having from 6 to 30 carbon atoms. Examples of suitable quaternary ammoniums (QAs) include, but are not limited to, benzalkonium chloride (also known as alkyldimethylbenzylammonium chloride (ADBAC)), benzethonium chloride (also known as hyamine), methylbenzethonium chloride, cetalkonium chloride, cetylpyridinium chloride, cetrimonium, cetrimide, dofanium chloride, tetraethylammonium bromide, didecyldimethylammonium chloride (DDAC), dimethyldioctadecylammonium chloride and domiphen bromide. In one embodiment, the quat is a dimethylbenzylalkylammonium chloride wherein the alkyl groups are dodecyl, tetradecyl, or hexadecyl or a mixture thereof. Examples of suitable quaternary phosphoniums (QPs) include, but are not limited to, tetrakis(hexadecyl)phosphonium chloride, tetrakis(tetradecyl)phosphonium chloride, triethyl(tetradecyl)phosphonium bromide, tributylhexadecylphosphonium bromide, tributyl(dodecyl)phosphonium chloride, (1-dodecyl)triphenylphosphonium bromide, trihexyl(tetradecyl)phosphonium chloride, trihexyl(tetradecyl)phosphonium dicyanamide, tributyl(cyanomethyl)phosphonium chloride, triphenyl(tetradecyl)phosphonium bromide, hexyltriphenylphosphonium bromide, (1-octyl)triphenylphosphonium bromide, (1-tetradecyl)triphenylphosphonium bromide, (1-hexadecyl)triphenylphosphonium bromide, heptyltriphenylphosphonium bromide, dimethyl(octyl) hexadecylphosphonium chloride, and trihexyl(tetradecyl)phosphonium chloride. In one embodiment, a blend of at least two different quats is utilized.

The system works by killing microbes on contact rather than adding radiation (e.g. ultraviolet (UV)) or chemicals in solution. The porous media has an intrinsic permeability of 10⁻⁶ centimeters squared or greater and hence does not rely on size-exclusion as the primary means of reducing microbial levels during passage of or holding of air, water, or other fluids. It is readily scalable as shown in applications that range from treatment of water from a small stormwater pipe or a small building's septic system to the needs of a skyscraper or metropolitan area.

The media has surfaces that have been coated with quats which have or potentially possess or engender antimicrobial properties to the resulting item.

The surfaces have been coated with quaternary ammonium or phosphonium based organic compounds which have or potentially possess or engender antimicrobial properties to the materials for the purposes of resisting microbial colonization associated with biofouling, material degradation, oxidation, odor production, sanitation, and fomite creation.

These surfaces could include those associated with the fluid conveyance and holding of fluids such as but not limited to tubing, couplings, tanks, heat-exchange systems, baffles, valves, controls, and monitoring devices. These surfaces also include the porous media used for filtration and the surface of the vessel that store the porous consolidated or unconsolidated particles.

The antimicrobial coating used to prepare the porous media can be prepared by using a paint base (e.g. acrylic and latex). As an example, a 1:1 volume ratio of water to paint base is mixed to form a diluted paint base (e.g., in proportions such as including 250 mL base, mixed with 250 mL water). 20 mL of a 80% (w/v) solution of a quat in water is added to the diluted paint base. In another embodiment, an organic solvent-based coating (e.g. epoxy or other organic solvent as used in many waterproofing coatings) can be used as the base coating to which the solution of quat is added. In another embodiment, the coating is a plastic (e.g. low density polyethylene, polyvinyl chloride (PVC), or nylon) or an elastomeric based (e.g. polyurethane, neoprene) substance. In one embodiment, the 80% solution comprises at least two different quats. The resulting mixture agitated vigorously in a blender or by stirring. In another embodiment, the paint or coating base is not diluted before adding quats. The mixture is then applied to the media for example by pouring over the media (e.g. gravel, plastic pellets) held in a sieve or the media can be dipped into the coating and spun to remove excess coating. The so-coated media can be spread to air dry or cured in an oven. After drying, the coated media are ready for use. As an example, the media is gravel thus coated are between 0.25 and 0.5 inches (0.64 cm to 1.3 cm) in diameter of rough shape. Rather than stones, one can use glass marbles or plastic spheres/pellets.

In one embodiment, a vessel (e.g. a column such as a tube) is packed with the media particles (such as pebbles, plastic spheres, wood, elastomers, cloth, plastic membranes, glass beads or fibers), where the surfaces have been prepared with one or more quats (e.g. a chloride anion) by coating (e.g. latex paint that has been prepared to include the quaternary ammonium salts).

In one embodiment, the media particles are placed in a vessel (e.g. a column used as antimicrobial treatment module), whereby the particles function as a treatment system for air, water, or other fluid streams and has a high intrinsic permeability, but is still able to achieve high levels of bacterial reduction. This enables treatment of a large flux of water with a minimal need for holding tanks or high-pressure pumps (that may consume excessive amounts of electrical power). A vessel of this nature allows for the high flow rate by avoiding extensive filtration techniques and does not require a holding tank for prolonged contact time. Additional modules (e.g. treatment columns), may be added to the vessel for removal of solid particles, filterables, or chemical pollutants.

In one embodiment biocide-treated porous media was produced by coating pea-gravel (a diameter of 0.64 cm to 1.3 cm) that was treated with a modified marine coating amended with a common quaternary ammonia disinfectant. These formulations were then tested for their water purification properties. The details of this formulation and tests are described elsewhere in this specification.

An experiment was designed with three sample categories (each with four replicates) plus a sterile water blank sample. The categories were: (1) ‘Pre’ which consisted of cooling tower water transferred from storage jugs directly into sampling bottles without exposure to any column or porous media; (2) ‘Treated’ which had 1 L of the cooling tower water passed through the antimicrobial treated porous media columns at a flow rate of approximately 4 L per min, such that contact of the test water with the column was approximately 15 s and the sample bottles were filled as the water exited the column; and (3) ‘control’ which consisted of 1 L of the cooling tower water passed through columns filled with coated gravel containing no antimicrobial agent at a flow rate of approximately 4 L per min and the sample bottles were filled as the water exited the column. The comparisons were designed to examine the relative reductions in control versus pre; treated versus pre; and treated versus control to evaluate the microbial reduction that can be attributed to the antimicrobial porous media in our columns.

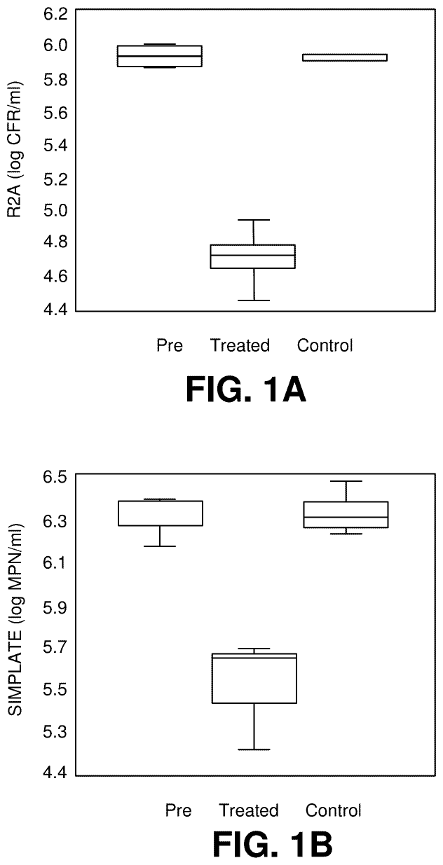

SimPlate and R2A spread plate techniques are utilized in this study to characterize a relatively broad diversity of bacteria from cooling water samples. The bacterial abundances of R2A plate counts and SimPlates in paired samples were found to be positively and linearly correlated (p<0.01, R2=0.916) (SimPlate=2.265×R2A+1.866×10⁵) across the examined experimental treatments. The initial (pre-column) concentrations of heterotrophic bacteria measured on R2A spread plates averaged 8.7×10⁵ CFU/mL (+1.3×10⁵, n=4) (FIG. 1A) and on SimPlates averaged 2.1×10⁶ (+5.5×10⁵, n=3) (FIG. 1B). Thus, there is a similar magnitude in the heterotrophic plate counts (HPC) concentrations by the two methods (6.32 (R2A) and 5.94 (SimPlate)) and there exists an appropriate initial abundance of assessable bacteria in the cooling water to conduct a meaningful evaluation of the efficacy of the biocontrol measure.

Bacterial levels from R2A plate counts were found to differ significantly among the employed treatments in these column experiments (F (2,9)=100.7, p>0.01) with no significant difference found between the ‘pre’ and the ‘control’ (p=0.99). However, significant differences were found between the ‘pre’ and the ‘treated’ (p<0.01) and between the ‘control’ and the ‘treated’ (p<0.01) (FIG. 1A). Similarly, assessable bacterial levels reported by SimPlate assays were found to differ significantly among the examined treatments in these column experiments (F (2,6)=12.48, p<0.01). No significant difference was found between the ‘pre’ and the ‘control’ (p=0.97), but significant differences were again found between ‘pre’ and ‘treated’ (p=0.013), as well as between the ‘control’ and the ‘treated’ (p=0.010) (FIG. 1B). The reduction in culturable bacterial following the brief (approximately 15 s) exposure involved in this test to the antimicrobial agent held in the porous media of the treated test columns (comparing ‘pre’ versus ‘treated’) averaged a 94% (+21%) reduction for R2A and an 83% (+35%) average reduction on SimPlates. Thus, the average of the two assessment methods in this test found a 1-log reduction.

This experiment employed relatively large diameter (<0.5 inches) gravel and a short-duration exposure (15 s) in a single-pass column configuration. The level of reduction in this experiment would likely have been greater, if these parameters were altered to values that would promote increased contact between the bacterial laden advecting fluids and the media-bound biocides. However, the specifics of an optimized configuration would depend on the characteristics of the system to be treated and the desired level of performance. For example, smaller media diameter, lower porosity, greater bed depth, and recirculation may be requisite in a cooling tower or an industrial water side stream filtration system, while the optimization for a passive urban stormwater filtration system (e.g., end-of-pipe treatment) may require a more permeable even though less microbial reducing design.

Without wishing to be bound to any particular theory, the mechanism of bacterial reduction for this porous media is believed to be cell lysis on contact with the treated media surface and is assumed to be the primary mechanism due to how the experiment was designed which reduces the potential for elution of the antimicrobial agent from the media coating as a secondary mechanism of biocontrol. The volume of tap water passed through each column prior to the test greatly exceeded the volume of pores in the column (>1,000 L, which is over 700 pore-volumes).

A variety of latext or acrylic paints were attempted with higher concentrations of quats (e.g. over 2%) but these were generally incompatible. Formulating a paint with high (e.g. <15 wt % quat) that provided acceptable antimicrobial activity was difficult. The components either separated or thickening/clumping causing poor consistency. Quats, by their nature, are cationic surfactants which are compounds that have portions that favor association with polar solvents and solutes and other portions that favor nonpolar solvents and solutes. Coatings are commonly chemical suspensions that are combinations of chemicals with differing levels of polarity. As such, when quats were added at levels greater than 3 (g/v) % the vast majority of tested coatings visually denatured. That denaturing took the form of clumping and even separating into multiple liquid layers. While some were stable at high quat levels, they did not result in proper coatings once applied to a porous surface. Only two versions were found to exhibit antimicrobial properties and they are both two-part epoxy from INTERLUX®. The first is Y2002E INTERPROTECT® White and the second is a related low-VOC version (Y2000VOC Gray).

TABLE 1

| Coating attempted | Observation | Summary |
|---|---|---|
| Latex paints- various | Not stable with high conc quats | Unacceptable |
| | added, coating separates/denatures/ | Coating |
| | clumps and not stable in water | |
| | flushing tests | |
| “Soft gel” coatings from | Could not tolerate high quat conc; | Unacceptable |
| “Golden”, Soft Gel Matte | good antimicrobial activity but | Coating |
| (#3013-5 from Golden, or from | coating not stable in water flushing | |
| Blick #00628-1237) thinned | tests. | |
| with water to accept quat, 40% | | |
| paint, 57% water, 3% quat. | | |
| H&C HYDRO-DEFEND ® | Unacceptable coating properties | Unacceptable |
| masonry waterproofing sealer | when mixed with quats; coating | Coating |
| | separated | |
| DRYLOK ® extreme masonry | Unacceptable coating properties when | Unacceptable |
| waterproofer | mixed with quats; clumping/thickening | Coating |
| SHERWIN WILLIAMS ® | Accepted quats but with poor | Unacceptable |
| LOXON ® XP masonry | properties and coating was soft and | Coating |
| waterproofing | not stable after submersion in | |
| | water- coating bubbled and flaked | |
| | off, became soft. | |
| BEHR ® 1 part concrete epoxy | Accepted quats but with poor | Unacceptable |
| | properties and coating was soft and | Coating |
| | not stable after submersion in | |
| | water- coating bubbled and flaked | |
| | off, became soft. | |
| INSLX- swimming pool | Accepted quat, but some softening | Unacceptable |
| masonry coating | when submerged and poor | Coating |
| | antimicrobial activity, some | |
| | leaching/foaming when submerged. | |
| RUST-OLEUM ®- advanced | Accepted quats but with thickening, | Unacceptable |
| acrylic exterior masonry | needed to have water added to thin | Coating |
| coating | before coating, some concerns on | |
| | coating hardness/durability, and | |
| | poor antimicrobial performance. | |
| “Art Glow” 2 part resin/epoxy | Mixed very well with quat but was | Unacceptable |
| | hard to use as coating (adhered | Coating |
| | particles together), was tried in | |
| | molds without particles, but was | |
| | not antimicrobial when tested. | |
| “Light speed” epoxy | Became cloudy and soft when mixed | Unacceptable |
| | with quats at high concentrations. | Coating |
| “ENVIROTEX ® lite epoxy | Mixed with quats but coating came | Unacceptable |
| pour on” | off media when submerged. | Coating |
| PETTIT ® Ezpoxy (Blue) | Could mix with high conc of quats | Unacceptable |
| | but Remained tacky and soft when | Coating |
| | mixed with high conc of quats, | |
| | gave off xylene when heated for | |
| | coating, coating shed after 5500 | |
| | gallons were flushed over 3 day | |
| | period. | |
| INTERLUX ® | Excellent mixing with quats, great | Acceptable |
| INTERPROTECT ®2000E | coating performance, can be | Coating |
| marine 2 part epoxy used as | warmed when applied or applied | |
| undercoating (non-ablative) and | without heat, hard coating but can | |
| contains microplates (white) | coat media without aggregates | |
| | forming, excellent durability after | |
| | flushing with water or submerging, | |
| | excellent antimicrobial activity | |
| | after flushing large volumes of | |
| | water. Could be applied to gravel, | |
| | pebbles, metal, plastic; recycled | |
| | glass particles | |
| INTERLUX ® | Excellent mixing with quats, great | Acceptable |
| INTERPROTECT ®VOC, | coating performance, can be | Coating |
| marine 2 part epoxy used as | warmed when applied or applied | |
| undercoating (non-ablative) and | without heat, hard coating but can | |
| contains microplates (grey), low | coat media without aggregates | |
| VOC coating | forming, excellent durability after | |
| | flushing with water or submerging, | |
| | excellent antimicrobial activity | |
| | after flushing large volumes of | |
| | water. Could be applied to gravel, | |
| | pebbles, metal, plastic; recycled | |
| | glass particles; lower VOC than | |
| | INTERLUX ® | |
| | INTERPROTECT ®2000E and | |
| | even less leaching or quat loss after | |
| | being submerged. | |

Without wishing to be bound to any particular theory, the two INTERLUX® coatings are believed to provide acceptable coating because they contain one or more particular components that, in combination, render the quat coatings stable, coat surfaces adequately while underwater and maintain antibacterial properties. The marine coating is water-stable when submerged for at least one day and is not water-based (e.g. <3 wt % water). In one embodiment, the marine coating comprises

Generally, a coating was deemed to be an acceptable coating if it could pass the following seven criteria: (1) Was the coating compatible with solutions (aqueous solutions and water/alcohol solutions) of a quat at high concentrations (e.g. above 4%, 4-10%, or up to 30%). If, when combined with the paint, the quat did not denature (e.g. coagulation, adverse thickening etc.) the paint such that its ability to coat materials was maintained, then the composition was deemed to have satisfied the first criteria. (2) Would the mixture form a stable coating on a glass slide and on an aluminum coupon (e.g. no flaking, bubbling, resist loss when rubbed with finger, resist loss when a metal object (such as a chisel or screwdriver was dragged across surface, was the coated surface sticky to the touch)). If the resulting coating persisted without damage after the aforementioned dragging test, then the mixture was deemed to have satisfied the second criteria. (3) Did the coated glass slide and aluminum coupon, when soaked in water for at least one day, result in a stable coating as delineated by the above tests. If the resulting coating could not be easily scratched off with the aforementioned dragging test, then the mixture was deemed to have satisfied the third criteria. (4) Was the coating stable on targeted porous media base (e.g. pea gravel, recycled glass particles, etc.). If the coated media did not flake, bubble or adversely aggregate, then the mixture was deemed to have satisfied the fourth criteria. (5) Was the quat-containing coating on the targeted porous media base stable when flushed by large volumes of water. If the coated media was stable under moving water for at least one day, then the mixture was deemed to have satisfied the fifth criteria. (6) Did the coating on the targeted porous media base significantly reduce bacterial loads in water flushed through the media. If bacterial loads were reduced in moving water, then the mixture was deemed to have satisfied the sixth criteria. (7) Did the quats (or other components of the coating) leach significant amounts when exposed to water (test by observation of foaming and in advanced chemical analysis of aqueous levels of components). If an acceptably low level of leaching occurred, then the mixture was deemed to have satisfied the seventh criteria.

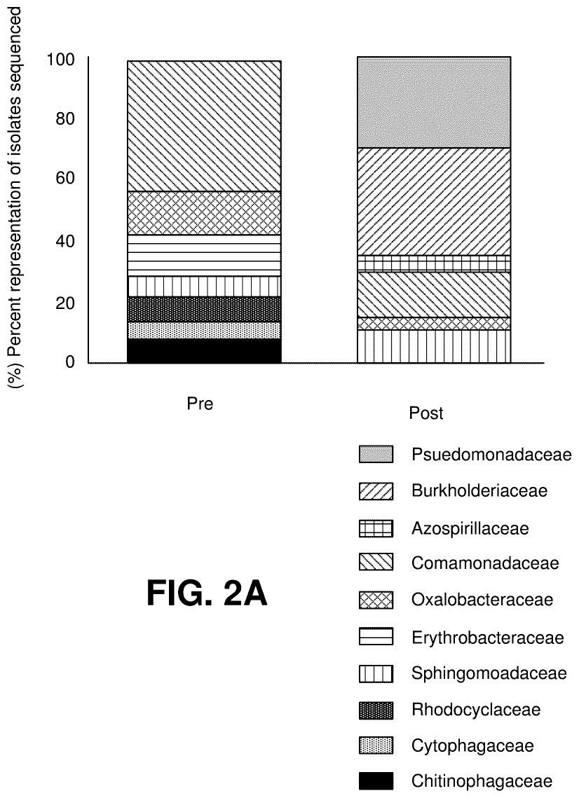

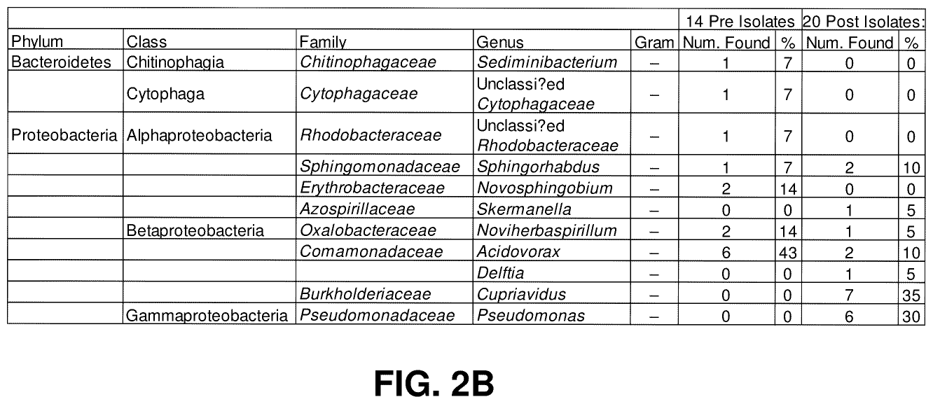

The taxonomic identification, utilizing 16S rRNA sequencing, of a small number of colonies from the R2A spread plates, pre- and post-column, demonstrates a relatively wide diversity of Gram-negative bacteria (FIG. 2A) and more importantly include taxa that have previously been demonstrated to be abundant in cooling tower systems. Alpha, Beta, and Gamma Proteobacteria have been determined to be the most common classes of bacteria in prior molecular genetic microbial surveys of cooling towers, as well as many other artificial freshwater distribution systems. All of the taxonomic families identified in the colony isolates (FIG. 2B), with the exception of Azospirillaceae are among the taxa found at high frequency in prior cooling tower DNA-based community surveys. For example, Comamonadaceae, Pseudomonadaceae, Burkholderiaceae, Sphingomonadaceae, and Rhodobacteraceae were among the most abundant families shared among the cooling towers. Chitinophagaceae were found to be highly persistent in some towers). Sediminibacterium, Acidovorax, Sphingomonas, and Novosphingobium were among the most abundant genera found in the cooling towers. Acidovorax, Pseudomonas, and Cupriavidus, were also commonly found genera in cooling towers and have been determined to thrive, at least transiently in protists which is an apparent strategy often found to be associated with cooling towers microbes. These findings suggest that while the cultivation-based tools used to assess bacterial abundance are known to culture only a subset of total cells, the assays used in this experiment were able to enumerate taxa thought to be important in these systems based on prior studies.

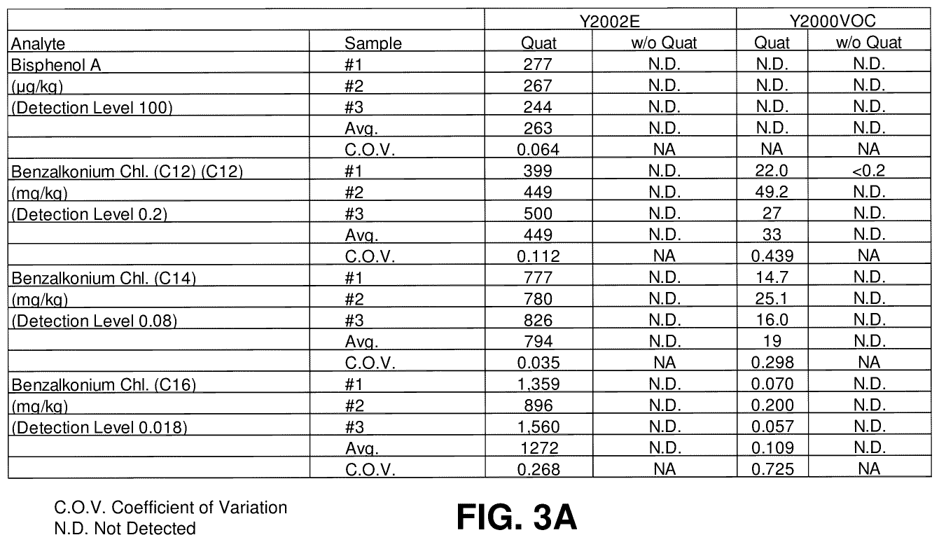

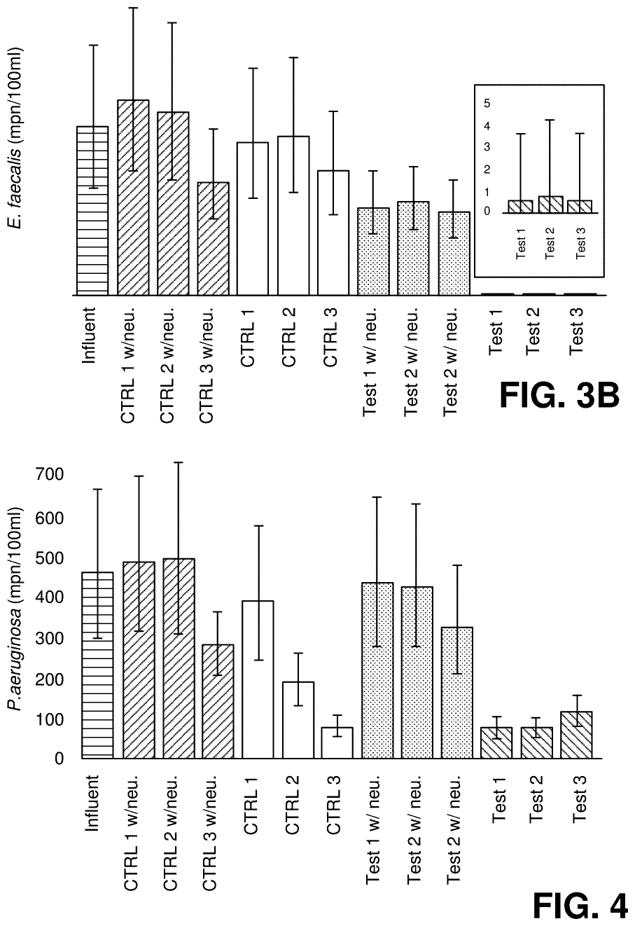

The methods of the water extraction study were designed to valuate the stability of the quat laced marine coatings and to screen which if any, might be suitable for further analysis of their antimicrobial efficacy. None of the test samples had the targeted VOCs found above the detection level (10 mg/kg). As seen in FIG. 3A, bisphenol A was only detected above detection levels (100 μg/kg) in the quat-containing Y2002E coating (avg. 263 μg/kg+0.064%, n=3). The three chain lengths of benzalkonium chlorides (C₁₂, C₁₄, and C₁₆) in the Pilot Chemical formulation were detected in both INTERLUX® coatings. The average mg/kg levels C₁₂, C₁₄, and C₁₆ ABDAC in three analyses of the Y2002E-based coating were 449 (+11.2%), 794 (+3.5%), and 1272 (+26.8%). The Y2000VOC releases were 33 (+43.9%). 19 (+29.8%), and 0.109 (+72.5%). These are significantly lower (92.7%, 97.6%, and 99.9%).

The MPN of bacteria per 100 mL of sample, plus the lower and upper CI for all samples are provided in Table 2. Table 3 and Table 4.

TABLE 2
Column Information for Targeted Bacterial tests.

| | | | | | |
|---|---|---|---|---|---|
| | | | | | Bulk |
| | | | Mass | | Density |
| | | Mass Dry | Media + | | Media |
| Column | Statistic | Media (g) | Water (g) | Porosity | (g/cm³) |

Enterococcus faecalis and Pseudomonas aeruginosa tests

| | | | | | |
|---|---|---|---|---|---|
| Control | Avg. | 783.1 | 2303.0 | 0.854 | 3.01 |
| (n = 3) | Stdev. | 0.458 | 3.943 | 0.002 | 0.04 |
| Test (n = 3) | Avg. | 847.1 | 2337.4 | 0.837 | 2.93 |
| | Stdev. | 0.551 | 1.600 | 0.002 | 0.02 |

Legionella pneumophila tests

| | | | | | |
|---|---|---|---|---|---|
| Control | Avg. | 674.9 | Not | Not | Not |
| (n = 2) | Stdev. | 0.283 | Recorded | Calculable | Calculable |
| Test (n = 2) | Avg. | 675.0 | | | |
| | Stdev. | 0.212 | | | |

TABLE 3
Removal of Enterococcus faecalis by Low-VOC Coated Media

| Column or | | | Effluent Conc. (MPN/100 ml) | | | Log₁₀ Conc. Reduction | | |
|---|---|---|---|---|---|---|---|---|
| Influent | | | | Lower | Upper | | Lower | Upper |
| Water | Neut. | Rep. | MPN | 95% | 95% | Avg. | 95% | 95% |
| Influent All | None | A | 488.4 | 310.0 | 721.5 | NA | NA | NA |
| Columns | | B | 248.1 | 162.3 | 371.9 | | | |
| | | C | 410.6 | 260.6 | 618.9 | | | |
| CTRL 1 | Yes | A | 430.3 | 273.2 | 630.0 | −0.07 | −0.07 | −0.06 |
| | | B | 483.6 | 306.9 | 722.2 | | | |
| | | C | 430.3 | 273.2 | 630.0 | | | |
| CTRL 2 | Yes | A | 406.0 | 257.7 | 617.2 | −0.04 | −0.03 | −0.04 |
| | | B | 430.3 | 273.2 | 630.0 | | | |
| | | C | 406.0 | 257.7 | 617.2 | | | |
| CTRL 3 | Yes | A | 275.7 | 180.3 | 413.2 | 0.17 | 0.15 | 0.18 |
| | | B | 217.3 | 142.2 | 325.4 | | | |
| | | C | 289.2 | 194.9 | 405.8 | | | |
| CTRL 1 | None | A | 307.6 | 195.3 | 471.2 | 0.04 | 0.05 | 0.04 |
| | | B | 344.8 | 218.9 | 520.7 | | | |
| | | C | 387.3 | 245.9 | 567.0 | | | |
| CTRL 2 | None | A | 275.5 | 185.7 | 416.8 | 0.02 | 0.02 | 0.02 |
| | | B | 387.3 | 245.9 | 567.0 | | | |
| | | C | 435.2 | 276.2 | 650.0 | | | |
| CTRL 3 | None | A | 260.3 | 175.4 | 365.2 | 0.13 | 0.12 | 0.13 |
| | | B | 325.5 | 206.6 | 498.1 | | | |
| | | C | 261.3 | 170.9 | 398.5 | | | |
| Test 1 | Yes | A | 211.6 | 150.8 | 282.3 | 0.28 | 0.25 | 0.30 |
| | | B | 152.9 | 109.0 | 213.7 | | | |
| | | C | 238.1 | 155.8 | 356.6 | | | |
| Test 2 | Yes | A | 253.6 | 175.8 | 359.0 | 0.26 | 0.22 | 0.29 |
| | | B | 205.6 | 146.6 | 284.8 | | | |
| | | C | 173.9 | 124.0 | 239.3 | | | |
| Test 3 | Yes | A | 184.9 | 128.2 | 260.0 | 0.31 | 0.28 | 0.33 |
| | | B | 163.0 | 116.2 | 223.4 | | | |
| | | C | 215.0 | 144.9 | 310.6 | | | |
| Test 1 | None | A | 0.5 | 0.0 | 3.7 | 2.88 | 2.39 | 2.19 |
| | | B | 0.5 | 0.0 | 3.7 | | | |
| | | C | 0.5 | 0.0 | 3.7 | | | |
| Test 2 | None | A | 1.0 | 0.1 | 5.5 | 2.76 | 3.87 | 2.12 |
| | | B | 0.5 | 0.0 | 3.7 | | | |
| | | C | 0.5 | 0.0 | 3.7 | | | |
| Test 3 | None | A | 0.5 | 0.0 | 3.7 | 2.88 | 2.39 | 2.19 |
| | | B | 0.5 | 0.0 | 3.7 | | | |
| | | C | 0.5 | 0.0 | 3.7 | | | |

TABLE 4
Removal of Legionella pneumophila by Low-VOC Coated Media

| Column | | | Effluent Conc. | | | | | |
|---|---|---|---|---|---|---|---|---|
| or | | | (MPN/100 ml) | | | Log₁₀ Conc. Reduction | | |
| Influent | | | | Lower | Upper | | Lower | Upper |
| Water | Neut. | Rep. | MPN | 95% | 95% | Avg. | 95% | 95% |
| 1156 | None | A | 1572. | 1156.0 | 2139.0 | NA | NA | NA |
| | | B | 1459. | 1087.2 | 1960.1 | | | |
| | | C | 1289. | 976.3 | 1704.2 | | | |
| CTRL 1 | None | A | 1289. | 976.3 | 1704.2 | 0.043 | 0.038 | 0.049 |
| | | B | 1162. | 888.5 | 1522.1 | | | |
| | | C | 1459. | 1087.2 | 1960.1 | | | |
| CTRL 2 | None | A | 1222. | 930.1 | 1606.6 | −0.560 | −0.628 | −0.512 |
| | | B | 1367. | 1028.1 | 1819.6 | | | |
| | | C | 1572. | 1156.0 | 2139.0 | | | |
| 1156 | None | A | 1572. | 1156.0 | 2139.0 | NA | NA | NA |
| | | B | 1367. | 1028.1 | 1819.6 | | | |
| | | C | 1572. | 1156.0 | 2139.0 | | | |
| Test 1 | None | A | <1.0 | 0.0 | 0.0 | 2.102 | 2.314 | 1.895 |
| | | B | 4.3 | 1.5 | 12.6 | | | |
| | | C | 30.9 | 14.7 | 65.1 | | | |
| Test 2 | None | A | <1.0 | 0.0 | 0.0 | 2.304 | 2.524 | 2.123 |

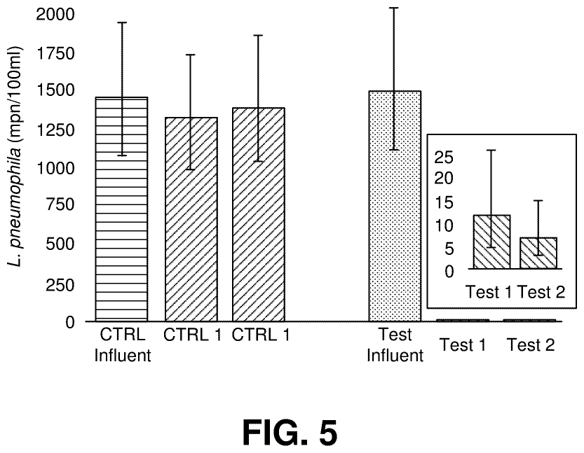

In FIG. 3B, FIG. 4 and FIG. 5 show the average of the three replicates with the error bars being the aver-age of the 95% CIs. Some of the analysis trays lacked even a single positive well, indicating a result below detection (a Most Probable Number (MPN) concentration of 1.0), that has been assigned a value of 0.5 MPN in the statistical analysis and in the plots, as is common practice for IDEXX analysis and other bacterial enumeration tests, representing a conservative approach to assessing the effectiveness of this technology.

For E. faecalis (FIG. 3B), the influent solution had an average MPN of 382.4 with the average lower and upper 95% CIs for the set of three replicates being 244.3 and 570.8. E. faecalis levels were found to differ significantly among the employed treatments (4,10)=14.42, p>0.01) with no significant differences found between influent and controls (neutralized and non-neutralized, p=0.90 and p=0.42, respectively), but significant reductions between influent and test (neutralized and non-neutralized, p=0.01 and p<0.01, respectively) as well as the test and control (neutralized and non-neutralized, p=0.02 and p<0.01, respectively) columns. Based on these results, it can be readily concluded that there was no discernable influence on the E. faecalis levels due to passage through the control media and nor is there an apparent impact of neutralization with D/E. There was no significant difference between neutralized and non-neutralized control columns (p=0.49), but the non-neutralized test columns did have significantly lower concentrations (p=0.01) compared to the neutralized test column.

Comparing the average MPN concentrations, the neutralized effluent of the three test solutions was 45-51% lower than the influent solution. In the nine samples of non-neutralized effluent waters (three test columns sampled three times each), only one tray had a single positive well equating to a calculated MPN concentration of 1.0 in that sample, indicating that the per-cent reductions are underestimated due to the majority of final concentrations falling below the detection limit. This also shows that significant additional bacteria are being lost due to the presence of eluted component(s) of the test media or that those eluted chemicals are interfering with the IDEXX reagents. Bisphenol A has been observed to impact E. faecalis at concentrations above 30 μg/mL, but this should not be of concern given that this component release study did not observe them at levels far below that (i.e., not found above detection levels of 0.100 μg/g). However, ABDAC was found to be released which points to its likely cause as the difference in observed microbial reductions between the neutralized and non-neutralized results.

For P. aeruginosa (FIG. 4), this should not be of concern given that this influent solution had an average MPN of 458.4 with the average lower and upper 95% CIs being 302.1 and 669.0. Given the similarities of the experimental and analytical methods, the range of uncertainty of P. aeruginosa in this work is similar to E. faecalis with the respective CIs being 34.1% below and 45.9% above the MPN, but the patterns of removal are overall more complicated. P. aeruginosa levels were found to differ significantly among the employed treatments (F (4,10)=7.772, p>0.01) with no significant differences found between influent and neutralized control (p=0.64) but a significant reduction between influent and non-neutralized control (p=0.01), and similarly no significant reduction between influent and neutralized test columns (p=0.46) but a significant reduction between influent and non-neutralized test (p<0.01). No significant differences were observed between control and test columns (neutralized and non-neutralized, p=0.78 and p<0.13, respectively), but significantly greater reductions were observed in neutralized compared to non-neutralized test columns (p<0.01).

For the quat-amended media, there is no discernable decrease in P. aeruginosa for the neutralized samples with all three having their average MPN levels falling within the range of variability of the influent solution. All three of the non-neutralized samples are significantly lower than the influent with log₁₀ reduction in concentration versus the average influent of 0.78, 0.79, and 0.60 for the three test columns.

The final bacteria examined was Legionella pneumophila (FIG. 5). As previously stated, additional handling and cost concerns resulted in minor changes in the experimental approach. These included different influent solutions being used for the control and test columns, sets of two rather than three control and test columns, and no neutralized column effluent samples. The average influent concentrations were 1,440.7 (n=3, +142.3) and 1,504.2 (n=3, +118.2) MPN/100 mL. By comparison in their examination of biocides for use in cooling towers Garcia and Pelaz used 1-3×10⁷ CFU/mL of L. pneumophila. By comparison a review of Legionella outbreaks attributed to cooling towers found in the literature that measured concentrations of 10-10⁷ CFU/mL, but cautioned that these levels may not represent levels during outbreaks. L. pneumophila levels were found to differ significantly among employed treatments (F (3,6)=115.3, p<0.01) with no significant differences found between influent and control (p=0.13), but significantly lower concentrations in test columns compared to both influent (p<0.01) and control columns (p<0.01).

It is worth noting that one of three Test 1 samples and 2 of 3 Test 2 samples reported no measurable levels of Legionella. Those non-detects are assigned estimated concentrations of 0.5 MPN/100 mL and using those values results in average effluent concentrations of 11.9 and 7.5 MPN/100 mL and log 10 units of loss 2.3 and 2.7. Greater performance in absolute and log reduction may exist when challenged with a more concentrated influent solution. The performance of this technology versus Legionella is noteworthy because past outbreaks have resulted in commercial HVAC and cooling towers systems being mandated to measure and control its levels in the state of New York.

### Methods

A coated porous media containing the ABDAC biocide was placed into four replicate polyvinyl chloride (PVC) columns and, for a control, four more columns were prepared with the same coated media, but without the antimicrobial agent. The columns were schedule 40 PVC pipes (ASTM D1785), each five feet long with an internal diameter of 2.047 inches that were vertically oriented with a cap at the bottom. After twenty 0.125-inch holes were drilled in the bottom cap, a similar volume of media was filled in the columns (54.0 (+0.5) inches). The design and permeability of the columns were such that gravity-fed water at a rate of approximately 3.8 L/min resulted in a fully saturated bed and steady flow rate through the column.

The subject biocide-treated porous media (four columns) comprised pea-gravel with a diameter of less than 0.5 inches that was treated with a modified marine coating amended with a common quaternary ammonia disinfectant. The marine coating was a two-part epoxy from INTERLUX® (a division of AkzoNobel) whose base is Y2002E INTERPROTECT® White, and the curing agent is INTERPROTECT®Y2001E. The base and curing agent were combined at a mass ratio of 79 and 21%. To that mixture was added the antimicrobial agent (MAQUAT MC1412-80), which was 80% (wt) active ingredients (alkyl (40% C₁₂, 50% C₁₄, 10% C₁₆)-dimethylbenzylammonium chloride (ADBAC)) sourced from Pilot Chemical. The ABDAC represented 18% by mass of the coating mixture prior to the application to the pea-gravel. In one embodiment, a benzoalkonium halide is selected that is a dimethylbenzylammonium alkane that is a C8, C10, C12, C14, C16 or C18 alkane.

ADBAC is a class of quaternary ammonium chemicals that is commonly employed in mixtures of different alkyl chain lengths (typically C10-C18) that, due to their antimicrobial properties against viruses, bacteria, and fungi, have broad and diverse applications. The high affinity for biological membranes of the cationic surfactant structure of the alkylated quaternary ammonium has been shown to act as an antimicrobial agent primarily through cellular lysis. In addition, alkylated quats in the form of surface chemically modified cellulose fiber, polymeric beads, nanoparticles, and poly(methyl methacrylate) have been found to exhibit antimicrobial properties. While alkylated quats have been instrumental in addressing the SARS-COV2 outbreak, affixing them to materials rather than freely dispersing them in waters is of interest in addressing this pathogen where electrostatic forces are thought to be at work. This method has the further potentially attractive result of lessening the introduction level of these biocides into the environment, which is of rising concern, and potentially increasing the cost-effectiveness of their use in water treatment.

The four control columns were constructed employing the same experimental setup but with a marine coating lacking the antimicrobial agent. The only difference between treated columns and control columns was the presence of the antimicrobial agent (ADBAC). This quaternary ammonium compound was immobilized within the coating of the porous media with the intention of physically lysing cells upon contact with the porous media surfaces. The porous media (treated and controlled) was flushed with greater than 1,000 L of tap water prior to passing cooling tower water through the columns. This action was intended to pre-condition the media and to evaluate coating durability prior to the experimental test. The columns were then exposed to cooling tower water collected from an operating industrial cooling tower basin in the northeastern United States. The cooling tower water was collected in eight replicate plastic 4-L jugs within 24 h prior to the column test and was stored at room temperature in the absence of direct sunlight exposure during transport to the laboratory and prior to testing.

Water used for microbial enumeration was collected in two sterile bottle types for each sample: (1) a 50 mL sterile tube for in-house (Queens College) laboratory analyses; and (2) a 250 mL sterile bottle for analysis at an external laboratory, EMSL Analytical Inc. In the case of EMSL, samples from only three of the four replicates for each treatment were processed due to project constraints, while the Queens College laboratory sampled all four replicates from each treatment. In addition, a blank, sterile water control was processed in parallel to the cooling tower water samples to control for contamination in sample handling, in addition to laboratory sterile dilution water method controls to ensure the laboratory reagents and media were not contaminated during sample processing or reagent preparation. The blank controls and sterile dilution water controls had no growth in any assay and are therefore not included in the experimental figures presented below.

Following completion of the column experiment, the collected samples were immediately processed by the Queens College laboratory (50 mL bottles), and parallel samples (250 mL bottles) were delivered to EMSL within 4 h. Bacterial enumerations (as described below) were initiated within 6 h of initial column exposure, following commonly accepted procedures and holding times. The cooling towers where the water originated were well maintained and unlikely to contain significant levels of Legionella but were expected to have a measurable total bacterial level. As a result, bacterial tests focused on broader hetero-trophic bacterial assays that are also of interest in HVAC maintenance and are similar to common assays (e.g., less quantitative dip slides) that are broadly used for functional and risk assessment in cooling towers. At Queens College, heterotrophic bacteria were quantified using spread plates incubated at 28° C. for 3 days on R2A media (Difco). The EMSL samples were processed using a SimPlate (Idexx) for heterotrophic bacterial estimation (method SM9215E; Standard Methods Committee of the American Public Health Association, American Water Works Association, and Water Environment Federation, 2022) and incubated at 35° C. for 2 days. Therefore, if the pattern of the results is well correlated across two laboratories employing similar but not identical methods of assessing heterotrophic bacterial concentrations, a high level of confidence would exist in the common findings.

After incubation and enumeration of bacteria on R2A spread plates, a small number of colonies were randomly selected, picked with a sterile pipette tip, PCR amplified for 16S rRNA genes, and sequenced at Eton Bioscience (Union, NJ) for taxonomic identification. That effort resulted in 34 sequences comprised of 20 from R2A plates incubated with cooling tower water that had passed through columns filled with the antimicrobial porous media and 14 from R2A plates incubated with pre-column cooling tower water. These Sanger sequences, consisting of 500-700 base pairs of high-quality sequence data, were then analyzed using the Bayesian rRNA Classifier tool of the Ribosomal Database Project to determine bacterial taxonomic associations with the sampled R2A colonies.

The compatibility of coatings with the chosen quats mixture was a focus of initial screening. In prior rudimentary exploration, numerous coatings were evaluated in largely qualitative tests based on visual analysis of whether the addition of the quat resulted in denaturing of the coating liquid, excessive foaming upon light agitation, or an apparently poor ability to evenly coat and adhere to the chosen target porous media (pea-gravel). The INTERPROTECT® coating discussed above (Y2002E Inter-protect White) showed promising compatibility and antimicrobial performance with the pea-gravel, but like many marine coatings, there is a relatively strong organic chemical odor likely indicating a significant release of VOCs during application. To address this issue, a related low-VOC version of the INTERLUX® coating (Y2000VOC Gray) was tested. This two-part epoxy from INTERLUX® uses the same curing agent and does have a noticeably lower release of VOC vapors during mixing, but more importantly, it is desirable to evaluate the potential stability of the quat-coatings when exposed to an aqueous system.

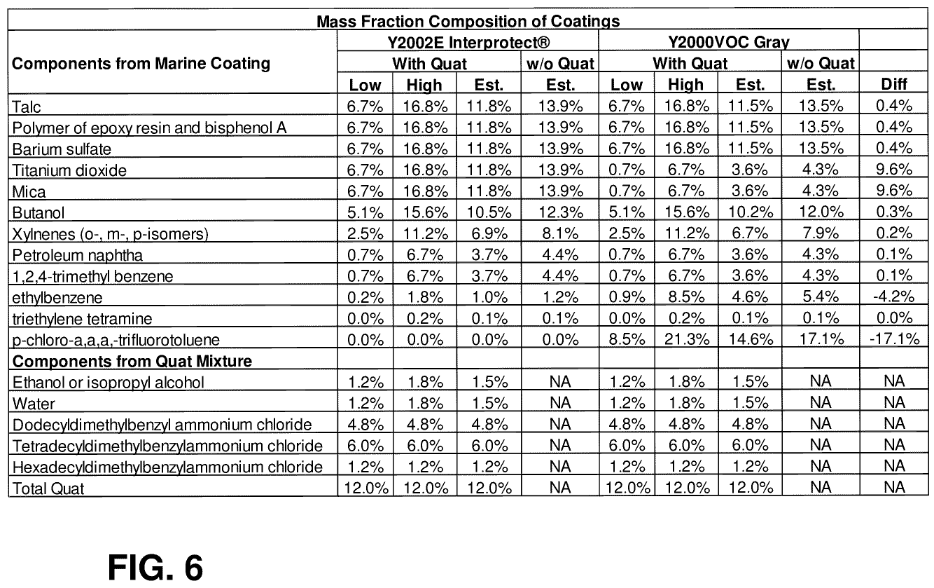

For evaluation of the potential release of coating components, the two marine coatings were mixed in ratios of 79/21 base to curing agent by mass. ABDAC versions of these were then diluted with MC1412-80 to the point that this addition represented 15% of the pre-application coating mass. See Table 5 and FIG. 6. The composition of the marine coatings was obtained from the supplier. Comparisons of the two INTERLUX® marine coatings show the main difference lies with the inclusion p-chloro-a,a,a-trifluorotoluene and potentially a greater amount of ethylbenzene in the low-VOC epoxy

TABLE 5
Column Information for Targeted Bacterial tests.

| | | | | | |
|---|---|---|---|---|---|
| | | | | | Bulk |
| | | | Mass | | Density |
| | | Mass Dry | Media + | | Media |
| Column | Statistic | Media (g) | Water (g) | Porosity | (g/cm³) |

Enterococcus faecalis and Pseudomonas aeruginosa tests

| | | | | | |
|---|---|---|---|---|---|
| Control | Avg. | 783.1 | 2303.0 | 0.854 | 3.01 |
| (n = 3) | Stdev. | 0.458 | 3.943 | 0.002 | 0.04 |
| Test (n = 3) | Avg. | 847.1 | 2337.4 | 0.837 | 2.93 |
| | Stdev. | 0.551 | 1.600 | 0.002 | 0.02 |

Legionella pneumophila tests

| | | | | | |
|---|---|---|---|---|---|
| Control | Avg. | 674.9 | Not | Not | Not |
| (n = 2) | | | Recorded | Calculable | Calculable |

In this manner a marine paint with high quat concentration is provided that is suitable for prolonged underwater use and provides antimicrobial activity. In one embodiment, the marine paint comprises a composition of matter as recited in Table 6 or Table 7.

TABLE 6

| Components of an embodiment of a marine paint | % (wt) |
|---|---|
| Talc | 12.0% ± 6% |
| Polymer of epoxy resin and bisphenol A | 12.0% ± 6% |
| Barium sulfate | 12.0% ± 6% |
| Titanium dioxide | 12.0% ± 6% |
| Silicate (e.g. Mica) | 12.0% ± 6% |
| Butanol | 11.0% ± 6% |
| Hydrocarbon solvent (e.g. petroleum naphtha) | 4.0% ± 5% |
| Xylenes (e.g., o-, m-, p-isomers) | 7.0% ± 5% |
| 1,2,4-trimethyl benzene | 4.0% ± 5% |
| ethylbenzene | 0.1-9.0% |
| triethylene tetramine | 0-0.2% |
| p-chloro-α,α,α,-trifluorotoluene | 0-22% |
| Organic alcohol (e.g. ethanol or isopropanol) | 0-2% |
| Water | 0-2% |
| Total Quats | 3%-15% |

TABLE 7

| Components of an embodiment of a marine paint | % (wt) |
|---|---|
| Talc | 12.0% ± 6% |
| Polymer of epoxy resin and bisphenol A | 12.0% ± 6% |
| Barium sulfate | 12.0% ± 6% |
| Titanium dioxide | 12.0% ± 6% |
| Silicate (e.g. Mica) | 12.0% ± 6% |
| Butanol | 11.0% ± 6% |
| Hydrocarbon solvent (e.g. petroleum naphtha) | 4.0% ± 5% |
| Arene solvent (e.g, o-xylene, m-xylene, o-xylene, 1,2,4- | 15% ± 12% |
| trimethyl benzene, ethylbenzene, combinations thereof) | |
| triethylene tetramine | 0-0.2% |
| p-chloro-α,α,α,-trifluorotoluene | 0-22% |
| Organic alcohol (e.g. ethanol or isopropanol) | 0-2% |
| Water | 0-2% |
| Total Quats | 3%-15% |

Coated materials were evaluated for the stability of the ABDAC-amended commercial epoxy coatings in aqueous systems. Cured unwashed samples of quat and non-quat-containing coatings of the Inter-protect coated pea-gravel at the ratios described above were evaluated. For this evaluation, 15 mL aliquots of each material were randomly selected. These were washed with 1 L of water, placed on a paper towel, and dried for 30 min. They were then placed in a 40 mL vial with 15 mL of DI water. Each sample was extracted at 20° C. for 24 h. Analysis for VOCs was performed using gas chromatography/mass spectrometry (GC/MS) following EPA Method 5021A (USEPA 2014). The specific VOCs which were assessed included ethanol, isopropanol, butanol, xylenes, 1,2,4-trimethylbenzene, ethylbenzene, and triethylene-tetramine. The solutions were also analyzed for levels of bisphenol A by liquid chromatography tandem mass spectrometry (LC/MS/MS) following ATS internal method (367 Rev. 1) and for levels of the type of quat used, benzalkonium chloride, by LC/MS/MS following EPA Method 83121B(USEPA 2007). This process was performed in triplicate for each material.

ABDAC-amended low-VOC-coated pea-gravel was provided to the Water & Energy Sustainable Technology Center (WEST) at the University of Arizona to evaluate its ability to reduce bacterial loads in water streams. The media was formulated in the same manner as examined by ATS for component release. The first set of studies examined the ability of the media to reduce Enterococcus faecalis (ATCC #19433) and Pseudomonas aeruginosa (ATCC #15442). The test of treatment performance of the media again each bacterium initially consisted of preparing three sets of columns with media, conditioning the media with flushing with bacteria-free solution, then flushing with a solution of a single bacteria where effluent levels at the end of the flush are compared with those of the influent. Specifically, quat-containing test media was placed to bed depths of 35.0 inches in three schedule 40 PVC columns whose inner diameter is 2.047 inches. In a similar manner, three identical columns were prepared with quat-free media to function as a control. Due to project constraints, these control columns were filled with slightly less media resulting in bed thicknesses of 33.0 inches. All six columns were individually pre-flushed with 300 L of dechlorinated tap water at flow rates of 3.4 L/min. The levels of chlorine were diminished through prior passage through activated carbon (Water-Tec of Tucson, Inc., CFT-CB10-10, 10-inch filter with 10 μm pore size, 100% coconut carbon).

At the conclusion of the pre-flush, 19 L of the bacterial solution was flushed through the columns. This involved preparation of a 190-litre stock solution of a single bacteria in dechlorinated water. The experimental system involved 24-inches of PVC (2-inch ID Schedule 40) connecting the influent tank to a peristaltic pump (Cole Parmer) followed by a 25-inch section of PVC to a flowmeter assembly. The system had an electronic digital meter (Great Plains Industries, Inc, Model #A109GMN02SNA1) with a 12-inch-long section of 2-inch PVC tubing located before and a 13-inch-long section after to enable accurate measurement conditions. From the flow meter assembly fluid passed through 36-inches of 0.5-inch internal diameter clear vinyl tubing (Everbilt, #HKP001-PVC009) to the column. The columns were oriented vertically with an induced upward flow to ensure fully saturated conditions within the columns. Effluent from the columns passed through a 106-inch section of the vinyl tubing to a second carboy where it could be sampled. The same set of control and test columns was used for both E. faecalis and P. aeruginosa testing. The pre-flushing dry mass of media placed in the columns and the water-saturated mass after the completion of the studies were measured.

Bacterial levels of the influent solution and effluent were assessed using reagent most probable number (MPN) techniques. In this experiment, three replicate 100 mL samples were collected from the influent solution and three from the column effluent at the 19-L flush point. Those were directly analyzed. A second set of three 90 mL samples of effluent water was also collected and partially diluted with 10 mL of Dey/Engle (D/E) neutralizing broth (Fisher). D/E broth is considered a broad-spectrum neutralizer because it contains several common chemical agents that have been found to be effectively neutralizing an array of biocides. The use of D/E agar as a means of neutralization was successful against an array of biocides including ADBAC when assessing their performance against common bacteria including P. aeruginosa, E. faecalis, and L. pneumophila.

E. faecalis levels were determined using Enterolert (IDEXX) (ASTM 2000) and P. aeruginosa using Pseudalert both employing the Quanti-Tray 2000 analytical option. After incubation, the number of positive wells in the trays is converted into an MPN concentration using the IDEXX software. That software also reports the lower and upper 95% confidence intervals (CI) for each sample.

Due to greater care needed in handling solutions of Legionella pneumophila, testing was performed in a class-2 biosafety hood (Fisher Scientific 1300 Series A2 (Model #1387)) which necessitated minor changes in methods. Specifically, shorter columns (2.047-inches diameter by 11-inches long) were employed, and studies were performed in duplicate rather than in triplicate columns. The columns were filled with 675 g of media resulting in 8.5-9 inches bed thicknesses in the columns. These tests employed the same pump and flow meter assembly, but otherwise only used vinyl tubing to convey solutions. Specifically, there was a 45-inch section of tubing between the influent carboy and the pump, followed by a 25-inch length to the meter assembly, then a 46-inch section to the column inlet, and an 82-inch section from the column to the second carboy. Different tubing was used for the control and test media columns.

In the Legionella studies, the pre-flush and bacterial solutions flushed through the columns were also 300 and 19 L. The flow rate for the Legionella studies was slightly greater at 3.8 liters per minute (L/min). The use of the biosafety hood necessitated that the control and quat columns be tested on separate solutions. Legionella pneumophila (ATCC #33152) was used in these experiments and its level in solution was determined using another IDEXX MPN method, with Legiolert media. That method is widely used in the testing of potable water systems and non-potable including cooling towers. Due to project constraints, deactivated samples were not prepared and due to exposure to L. pneumophila, the saturated columns could not be taken from the hood for measurement of post-saturated mass.

The disclosed treatment system may be a component within a larger setup that may involve usage of pumps, gravity, or pressure differences to induce flow through the porous media containing antimicrobial treatment module.

The disclosed system is useful in treatment of industrial and commercial process waters, fluids, and gases. For example, the system may be used as a treatment prior to other forms of treatment such as filtration, ultrafiltration, reverse osmosis, sorption, chemical or biological treatment, or radiation.

The system can also be utilized in storm-waters, sewage-contaminated waters (e.g. receiving waterways or combined sewage and stormwater), septic discharge, removal of microbial contamination in pool and spa installations, runoff from land to water bodies, heat exchangers, heating, ventilation, and air conditioning (HVAC) filtration and evaporative coolers, for the purposes of either safe-handling, for treatment, water re-use, or for protection of the quality of receiving waters or air. These systems can be used as an initial treatment component of a larger system toward these goals or as distributed, efficacious treatment systems, as might be used for urban storm-waters or agriculture.

In heating, ventilation and air conditioning applications, evaporative coolers and heat exchangers or filters are commonly used for removal of dust, microbes, or organic chemicals and for the purposes of exchanging thermal energy or humidity (e.g. heat exchangers and evaporative coolers). Those filters are often compromised owing to the activities of various classes of microbes. The disclosed system adds quaternary ammonium or phosphonium salts that are supported on media particles, on structural or HVAC components (such as ducts, walls of venting systems, or fan blades), or into the filter itself. As an example, it would specifically include the chemical binding or coating quats to the wood fiber or other materials comprising the filters commonly used in evaporative coolers.

In thermal exchange systems water, glycol, and other liquids are commonly used. The disclosed quat treated particles and quat treated surfaces may be used for the purposes of making those surfaces and particles antimicrobial to reduce microbial levels in these fluids and to reduce the level of viable microbes in bioaerosols. Examples of such an application may include evaporative coolers where wood pads in these systems have been treated or chemically bound with quats.

After prolonged use, the media particles can be recycled. The recycling may occur by solvent washing, ion exchange, incineration, thermal regeneration, acid or chemical digestion, mechanically ablating (e.g. grinding), particle blasting (sand, walnut, etc.) and other similar processes.

The recycling process removes cellular debris following cell lysis, from microbes, organic and inorganic ions or precipitates, low-solubility organic chemicals, geologic materials or other general debris encountered during use of the media.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A marine paint comprising:
less than 5% (wt) water;
greater than or equal to 3% (wt) of at least one quaternary ammonium salt;
12%±6% (wt) talc;
12%±6% (wt) of a polymer formed from an epoxy resin and bisphenol A;
12%±6% (wt) barium sulfate;
12%±6% (wt) titanium dioxide;
12%±6% (wt) a silicate;
11%±6% (wt) butanol;
5%±4% (wt) of a hydrocarbon solvent;
15%±12% (wt) of an arene solvent;
0-0.2% (wt) of triethylene tetramine;
0-22% (wt) of p-chloro-a, a, a,-trifluorotoluene; and
0-2% (wt) of an organic alcohol.

2. The marine paint as recited in claim 1, wherein the at least one quaternary ammonium salt is present at a concentration of at least 5% (wt).

3. The marine paint as recited in claim 1, wherein the at least one quaternary ammonium salt is present at a concentration of at least 10% (wt).

4. The marine paint as recited in claim 1, wherein the silicate is mica.

5. The marine paint as recited in claim 4, wherein the arene solvent comprises one or more arenes selected from the group consisting of o-xylene, m-xylene, o-xylene, 1,2,4-trimethyl benzene, ethylbenzene and combinations thereof.

6. The marine paint as recited in claim 4, wherein the hydrocarbon solvent is petroleum naphtha.

7. The marine paint as recited in claim 4, wherein the at least one quaternary ammonium salt is a benzalkonium halide.

8. The marine paint as recited in claim 4, wherein the at least one quaternary ammonium salt comprises a dimethylbenzalkonium halide with an alkane having C8, C10, C12, C14, C16 or C18 carbons.

9. The marine paint as recited in claim 4, wherein the at least one quaternary ammonium salt comprises a C12 dimethylbenzalkonium halide, a C14 dimethylbenzalkonium halide and a C16 dimethylbenzalkonium halide.

10. The marine paint as recited in claim 4, wherein the at least one quaternary ammonium salt comprises didecyldimethylammonium.

11. The marine paint as recited in claim 4, wherein the marine paint is copper-free and silver-free.

12. A composition of matter comprising:
a plurality of porous media particles;
a coating disposed on an external surface of the porous media particles within the plurality of porous media particles, the coating formed from:
applying the marine paint as recited in claim 1 to the external surface; and
waiting for the marine paint to dry, thereby forming the coating.

13. The composition of matter as recited in claim 12, wherein the at least one quaternary ammonium salt is present at a concentration of at least 5% (wt).

14. The composition of matter as recited in claim 12, wherein the at least one quaternary ammonium salt is present at a concentration of at least 10% (wt).

15. The composition of matter as recited in claim 12, wherein the plurality of porous media particles are pea-gravel with a diameter of 0.64 cm to 1.3 cm.

16. The composition of matter as recited in claim 12, wherein the marine paint is silicon-free, copper-free and silver-free.

17. A marine paint comprising:
less than 5% (wt) water;
greater than or equal to 5% (wt) of at least one quaternary ammonium salt;
12%±6% (wt) of a polymer formed from an epoxy resin and bisphenol A;
12%±6% (wt) barium sulfate;
12%±6% (wt) a silicate;
5%±4% (wt) of a hydrocarbon solvent;
15%±12% (wt) of an arene solvent;
0-0.2% (wt) of triethylene tetramine;
0-22% (wt) of p-chloro-a, a, a,-trifluorotoluene; and
0-2% (wt) of an organic alcohol.

18. The composition of matter as recited in claim 17, wherein the at least one quaternary ammonium salt is present at a concentration of at least 10% (wt).

19. The composition of matter as recited in claim 18, wherein the silicate is mica.

20. A marine paint comprising:
less than 5% (wt) water;
greater than or equal to 5% (wt) of at least one quaternary ammonium salt;
12%±6% (wt) of a polymer formed from an epoxy resin and bisphenol A; and
12%±6% (wt) a silicate.
